(19) United States
(12) Patent Application Publication
(10) Pub. No.: US 2005/0071738 A1
(43) Pub. Date: Mar. 31, 2005

(54) Scan document identification-send scanning using a template so that users can handwrite the destination and identification information

(76) Inventors: David J. Park, Torrance, CA (US); Vincent Wu, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/675,688

(22) Filed: Sep. 30, 2003

(51) Int. Cl. G06F 17/00

(52) U.S. Cl. 715/500

(57) ABSTRACT

This invention is directed to a system and method for processing electronic documents. The system and method involve using a template sheet onto which an associated user writes instructions for processing of the electronic document. Such a system and method for processing electronic documents is easier, faster, and more user-friendly. The system and method allows users to conveniently and quickly set up processing instructions by eliminating or minimizing graphical user interfaces or machine interfaces. Such a system and method is helpful to regular users who may not be technologically savvy as it only involves minimal information from the user to process the documents.

### BACKGROUND OF THE INVENTION

This invention is directed to a system and method for processing electronic documents. More particularly, this invention is directed to a system and method for using an associated template sheet for controlling the processing and routing of the electronic documents.

Typically, when a user uses a scanning device, copying device, or other document reading device, the user desires to performing further processing on the generated image data, such as sending to an electronic mail server or a network folder. In order to perform further processing the user has to access the image data and then go through a cumbersome process of setting up the details for the further processing. For example, a user would have to use a graphical user interface or imaging device interface to provide instructions for the further processing of the generated image data. This multiple step process is time consuming, confusing, and prone to error. Such a process can be very complicated such that it may require a steep learning curve for users.

There is a need for a system and method for easily performing processing on electronic documents or generated image data.

### SUMMARY OF THE INVENTION

In accordance with the present invention, there is provided a system and method for processing electronic documents.

Further, in accordance with the present invention, there is provided a system and method for easily performing processing on electronic documents or generated image data.

Still further, in accordance with the present invention, there is provided a system for processing electronic documents comprising image generating means adapted for generating an electronic representation of a paper document. The image generating means include means adapted for receiving an associated template sheet inclusive of an instruction representative of a desired document processing operation. The system also comprises optical recognition means adapted for recognition of the instruction, means adapted for generating an instruction signal in accordance with a recognized instruction, and means adapted for controlling processing of the electronic representation of a paper document in accordance with the instruction signal.

In one embodiment, the system further comprises means adapted for identifying a location of relevant markings on the template sheet. In a preferred embodiment, the means adapted for identifying a location of relevant markings comprised as at least one of check boxes and fill-in boxes. In other embodiment, the system comprises means adapted for optically identifying handwritten characters on the template sheet.

Still further, in accordance with the present invention, there is provided a method for processing of electronic documents comprising the steps of generating an electronic representation of a paper document, receiving an associated template sheet inclusive of an instruction representative of a desired document processing operation, and optically recognizing of the instruction. The method further comprises the steps of generating an instruction signal in accordance with a recognized instruction and controlling processing of the electronic representation of a paper document in accordance with the instruction signal.

In one embodiment, the method further comprises the step of identifying a location of relevant markings on the template sheet. In a preferred embodiment, identifying a location of relevant markings comprises identifying at least one of check boxes and fill-in boxes. In another embodiment, the method further comprises the step of optically identifying handwritten characters on the template sheet.

These and other advantages, aspects, and features will be understood by one of ordinary skill in the art upon reading and understanding the specification.

### BRIEF DESCRIPTION OF THE DRAWINGS

FIG. 1 is a block diagram illustrating the preferred embodiment of the system according to the present invention.

FIG. 2 is a flow chart illustrating the method according to the present invention.

FIG. 3 is a sample template for selecting the desired parameters for routing the electronic document to electronic mail address or a facsimile device.

FIG. 4 is a sample template for selecting the desired parameters for routing the electronic document to a network folder or document management system.

FIG. 5 is a sample template for selecting the desired parameters for routing the electronic document to an FTP server.

FIG. 6 is a sample template for selecting the desired parameters for routing the electronic document to the storage medium of the document reading device or other agent or device.

### DETAILED DESCRIPTION OF THE PREFERRED EMBODIMENT

This invention is directed to a system and method for processing electronic documents. The system and method involve using a template sheet onto which an associated user writes instructions for processing of the electronic document. Such a system and method for processing electronic documents is easier, faster, and more user-friendly. The system and method allows users to conveniently and quickly set up processing instructions by eliminating or minimizing graphical user interfaces or machine interfaces. Such a system and method is helpful to regular users who may not be technologically savvy as it only involves minimal information from the user to process the documents.

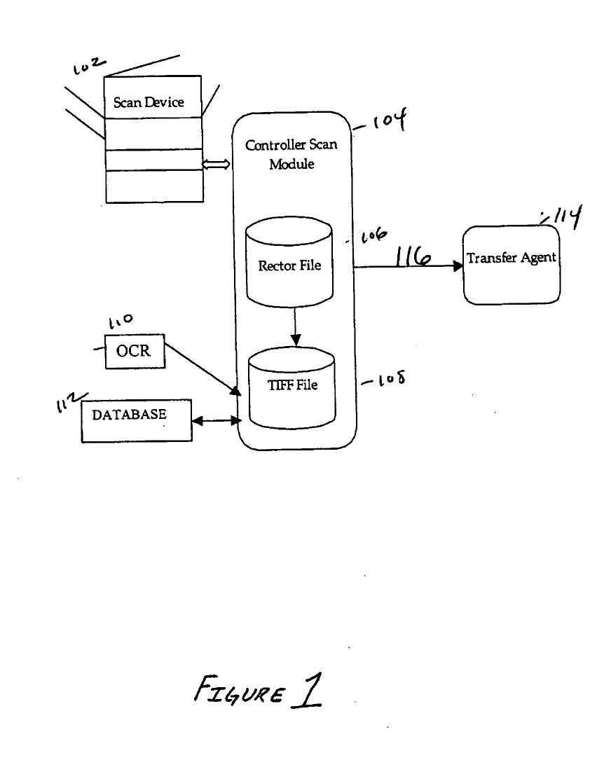

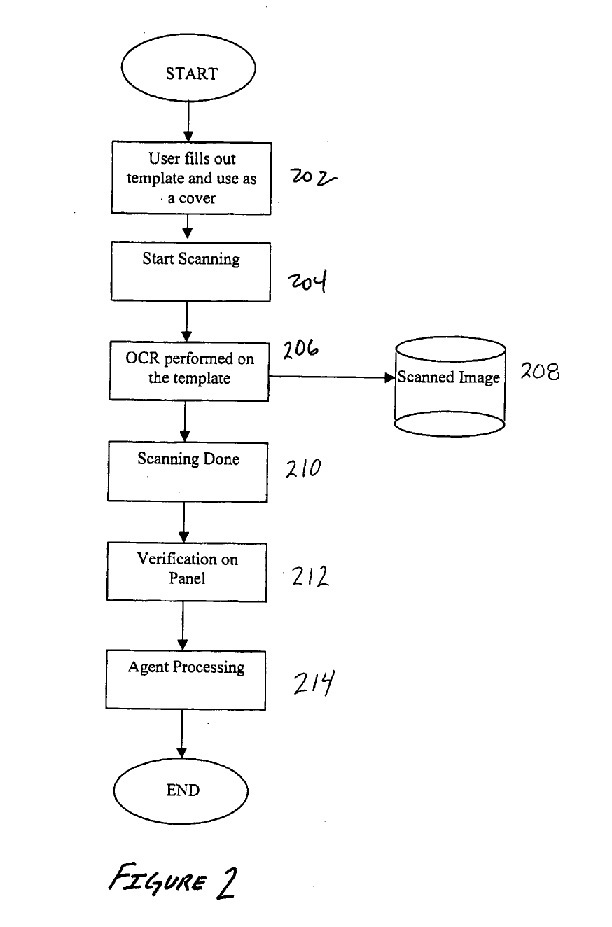

FIG. 1 shows a block diagram preferred embodiment of the system according to the present invention generally designated as 100. The system comprises a document reading device 102, such as a scanner or copier, for generating image data. The document reading device is any suitable document reading device known in the art. Preferably, the document reading device is a scanning device, a copying device, and a facsimile device. More preferably, the document reading device is a scanning device. Suitable commercially available document reading devices include, but are not limited to, the Toshiba e-Studio Series Controller. The document reading device further comprises a controller 104 which controls the functions of the document reading device and includes storage means for storing the image data.

In operation, the user inputs the document or other data into the document reading device to generate the image data and selects the desired settings for generating the image data. The image data is stored as a rector file 106 on the controller or any other suitable memory device. The image data is then converted by the controller to an appropriate format, such as TIFF, as shown by 108.

The system also includes an optical character recognition device 110 for performing optical character recognition on the template sheet containing processing instructions as discussed in detail below. The system also includes a database or other suitable storage means 112 for storing the generated image data and the template sheets on which optical character recognition has been performed. Preferably, the generated image data and template sheets are transferred to the database via any suitable means.

A Transfer Agent 114 is used to access the image data on the controller. An data transfer session is initiated on the communication link 116 whereupon the image data is transferred to the transfer agent via a data transfer system. The communication link is comprised of one or more segments of wired or wireless communications.

In a preferred embodiment, the controller 104 includes means adapted for selecting the desired settings for generating the image data. The electronic documents are routed to any suitable destination or processed via any suitable means. Preferably, the electronic documents are routed via electronic mail transmission, facsimile transmission, FTP transmission, HTML transmission, and optical image rendering on an associated display. Preferably, the electronic documents are routed to the following types of destinations: electronic mail server, a document management system, an image generating device, and an Internet server.

FIG. 2 illustrates a flow chart 200 for processing electronic documents according to the present invention. To start the process, the user completes a template sheet at 202 providing instructions for the desired processing operation for the electronic document via any suitable means. Preferably, the template has a set format for each destination or processing method and is the same for all users. In one embodiment, the template is provided in electronic form and generated by the user by any suitable means. In another embodiment, the template is provided in paper form to the user. The user enters the required information via any suitable means. In embodiment, the user enters the required information electronically via any suitable means and generates the template via any suitable means. In another embodiment, the user enters the required information with a suitable writing device. Preferably, the completed template sheet is used as a cover sheet for document to be processed.

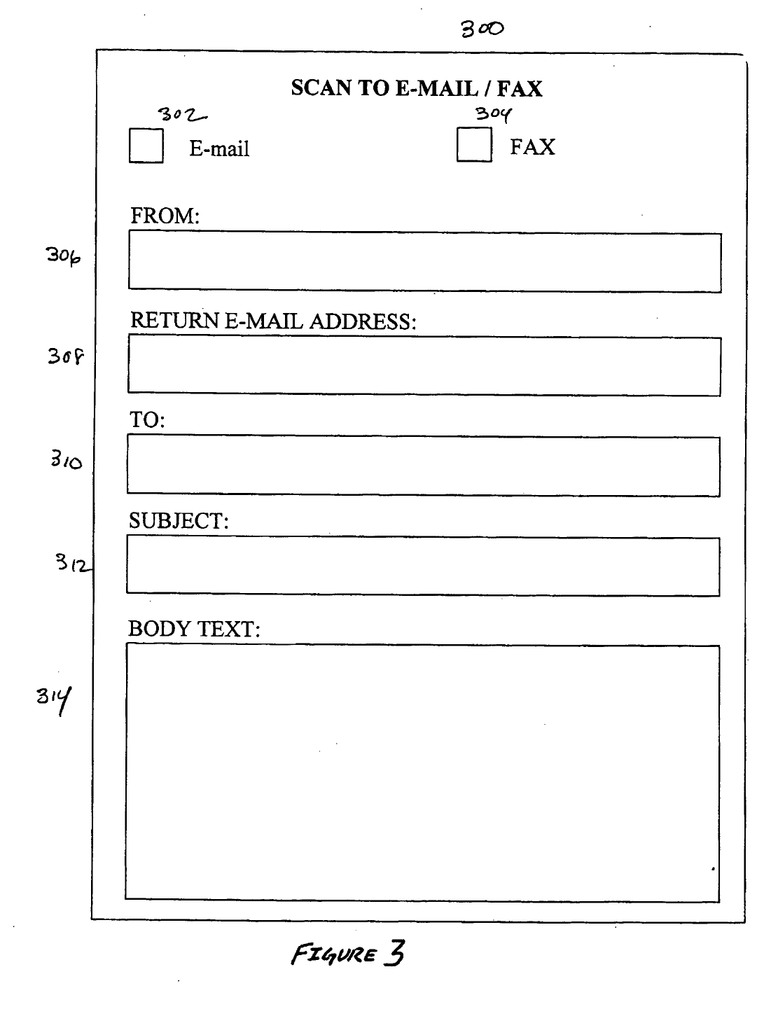

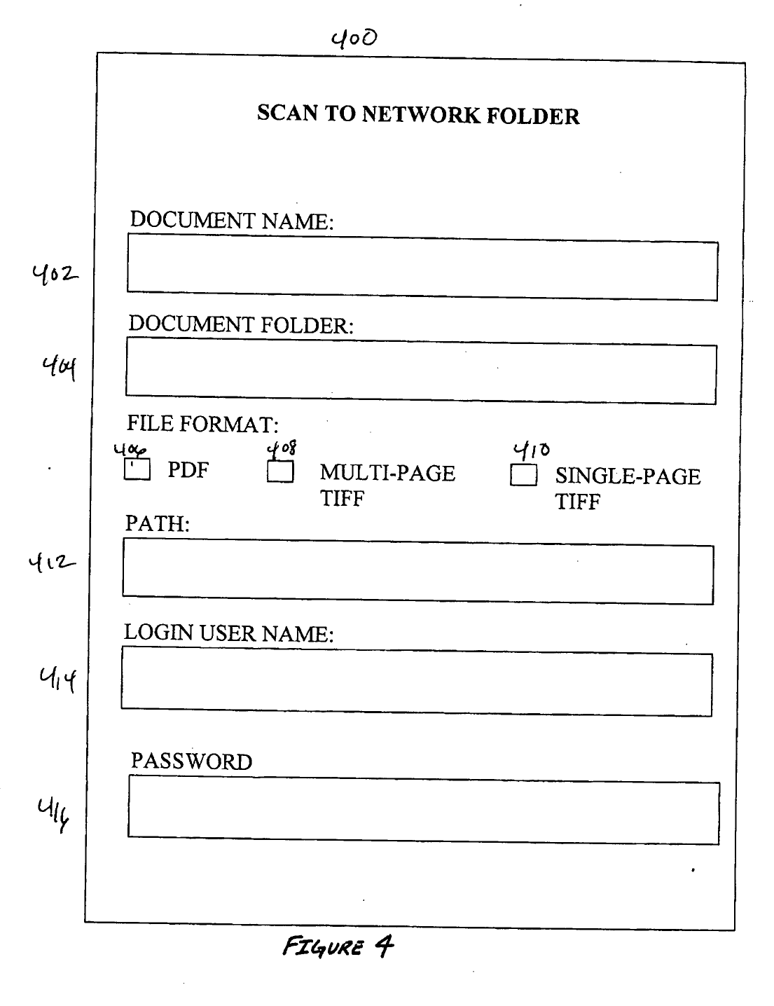

A sample template 300 for routing the electronic document to electronic mail or to a facsimile is shown in FIG. 3. The user selects either e-mail by checking box 302 or facsimile by checking by 304. The user then inputs information for from whom the document is being sent at 306, the user's return e-mail address at 308, to whom the document is being sent at 310, the subject at 312, and the text of the message at 314. The information is entered via any suitable means.

A sample template 400 for routing the electronic document to a network folder is shown in FIG. 4. The user enters the document name at 402 and the document folder at 404. The user selects the desired file format as PDF by checking box 406, as multi-page TIFF by checking box 408, or as single page TIFF by checking box 410. The user also enters the specified path at 412, the user's login name at 414, and the user's password at 416. The information is entered via any suitable means.

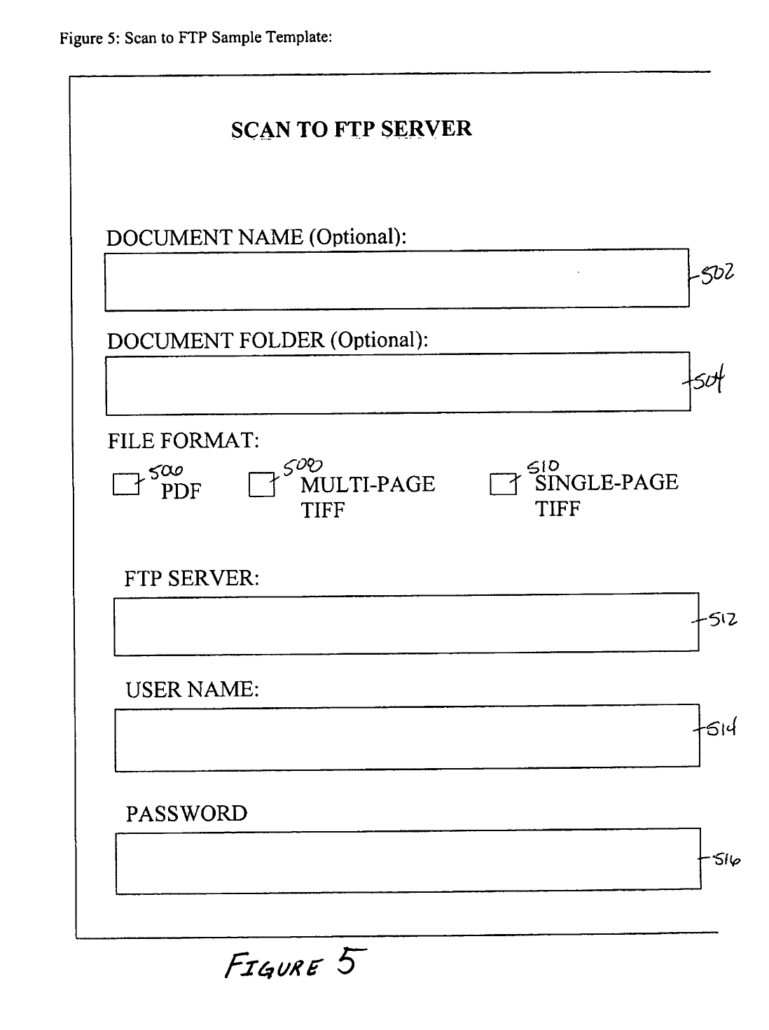

FIG. 5 shows a sample template 500 for routing the electronic document to an FTP server. The user enters the document name at 502 and the document folder at 504. The user selects the desired file format as PDF by checking box 506, as multi-page TIFF by checking box 508, and as single page TIFF by checking box 510. The user enters the FTP server at 512, the user's login name at 514, and the user's password at 516. The information is entered via any suitable means.

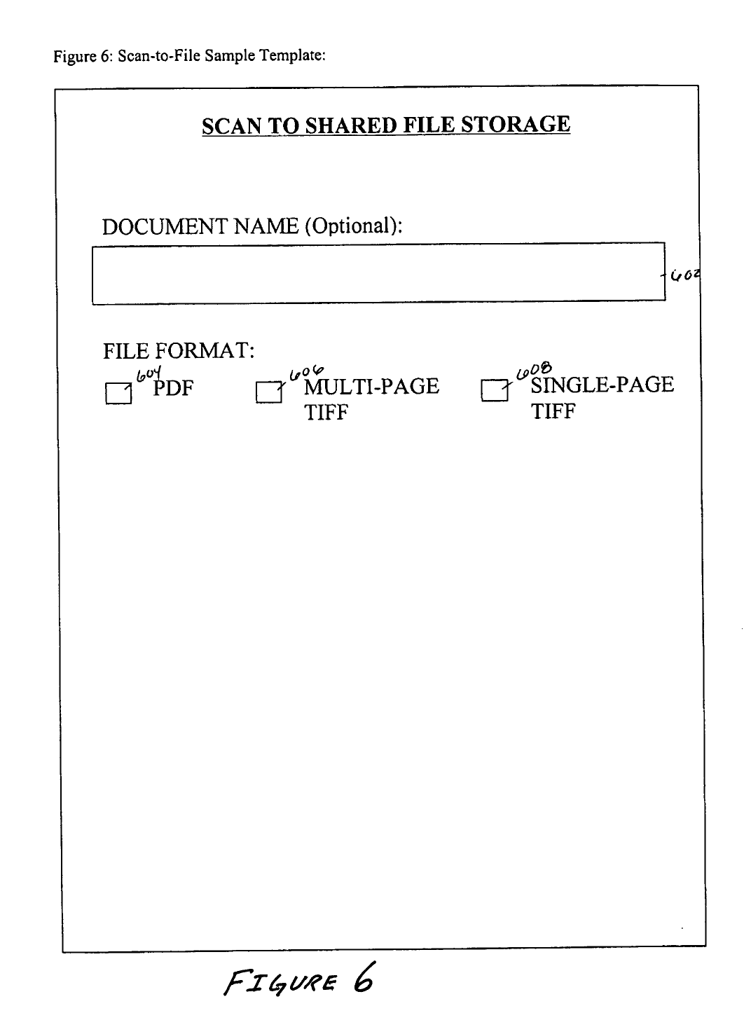

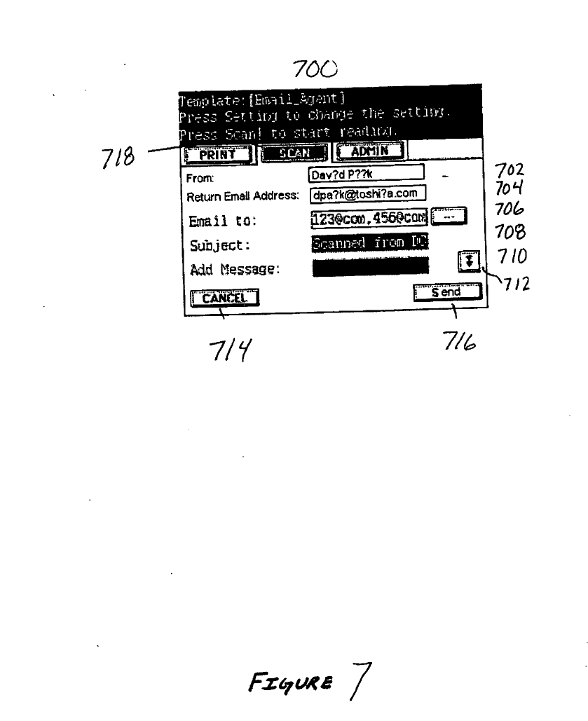

FIG. 6 shows a sample template 600 for routing the electronic document to the storage medium of the document reading device or other suitable device or agent. The user enters the document name at 602. The user selects the desired file format as PDF by checking box 604, as multi-page TIFF by checking box 606, and as single page TIFF by checking box 608. The information is entered via any suitable means.

At 204, the imaging operation is initiated via any suitable means to generate image data of the document. Preferably, the user inputs the document or other data into the document reading device to generate the image data and selects the desired settings for generating the image data.

At 206, optical character recognition will be performed on the template sheet via any suitable means to extract the instructions from the template sheet for processing the electronic document in accordance with the desired instructions. The resulting template on which optical character recognition has been performed is stored in the database via any suitable means as shown at 208.

Once the image generating of the document is completed as shown at 210, the user will have the opportunity to verify the instructions via any suitable means to ensure that the instructions for processing are correct at 212. A sample screen display 700 for verifying the instructions to route the electronic document to an electronic mail agent is shown in FIG. 7. From whom the mail is sent is shown at 702, the return electronic mail address is shown at 704, to whom the email is being sent is shown at 706, the subject is shown at 708, and the message is shown at 710. The user may suitably scroll through the message by pressing the scroll arrow at 712. Any unrecognized characters will preferably be displayed with a “?”. The user suitably changes the information via any suitable means, such as a touch screen on the document reading device. The user may cancel the changes by selecting Cancel 714. The user may start the image generating by selecting Scan 716. The user may complete the processing by selecting Send 718.

Once the user has completed the verification process, the electronic document is routed or processed according to the instructions as shown at 214. Preferably, the electronic document is routed to only one destination for each image generating action.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

1. A system for processing of electronic documents comprising:
image generating means adapted for generating an electronic representation of a paper document;
the image generating means including means adapted for receiving an associated template sheet inclusive of an instruction representative of a desired document processing operation;
optical recognition means adapted for recognition of the instruction;
means adapted for generating an instruction signal in accordance with a recognized instruction; and
means adapted for controlling processing of the electronic representation of a paper document in accordance with the instruction signal.

2. The system for processing of electronic documents of claim 1 further comprising means adapted for identifying a location of relevant markings on the template sheet.

3. The system for processing of electronic documents of claim 2 wherein the means adapted for identifying a location of relevant markings comprised as at least one of check boxes and fill-in boxes.

4. The system for processing of electronic documents of claim 1 further comprising means adapted for optically identifying handwritten characters on the template sheet.

5. The system for processing of electronic documents of claim 1 wherein the instruction signal directs routing of the electronic representation of a paper document in accordance with the instruction as indicated by optically identified handwritten characters.

6. The system for processing of electronic documents of claim 5 wherein the routing includes at least one of electronic mail transmission, facsimile transmission, FTP transmission, HTML transmission, and optical image rendering on an associated display.

7. The system for processing of electronic documents of claim 6 wherein the electronic representation of a paper document is routed to at least one of an electronic mail server, a document management system, an image generating device, and an Internet server.

8. The system for processing of electronic documents of claim 1 further comprising verification means adapted for verifying the desired document processing operation.

9. A method for processing of electronic documents comprising the steps of:
generating an electronic representation of a paper document;
receiving an associated template sheet inclusive of an instruction representative of a desired document processing operation;
optically recognizing of the instruction;
generating an instruction signal in accordance with a recognized instruction; and
controlling processing of the electronic representation of a paper document in accordance with the instruction signal.

10. The method for processing of electronic documents of claim 9 further comprising the step of identifying a location of relevant markings on the template sheet.

11. The method for processing of electronic documents of claim 10 wherein identifying a location of relevant markings comprises identifying at least one of check boxes and fill-in boxes.

12. The method for processing of electronic documents of claim 9 further comprises the step of optically identifying handwritten characters on the template sheet.

13. The method for processing of electronic documents of claim 9 wherein the instruction signal directs routing of the electronic representation of a paper document in accordance with the instruction as indicated by optically identified handwritten characters.

14. The method for processing of electronic documents of claim 13 wherein the routing includes at least one of electronic mail transmission, facsimile transmission, FTP transmission, HTML transmission, and optical image rendering on an associated display.

15. The method for processing of electronic documents of claim 14 wherein the electronic representation of a paper document is routed to at least one of an electronic mail server, a document management system, an image generating device, and an Internet server.

16. The method for processing of electronic documents of claim 9 further comprising the step of verifying the desired document processing operation.

17. A computer-readable medium for processing of electronic documents comprising:
image generating means adapted for generating an electronic representation of a paper document;
the image generating means including means adapted for receiving an associated template sheet inclusive of an instruction representative of a desired document processing operation;
optical recognition means adapted for recognition of the instruction;
means adapted for generating an instruction signal in accordance with a recognized instruction; and
means adapted for controlling processing of the electronic representation of a paper document in accordance with the instruction signal.

18. The computer-readable medium for processing of electronic documents of claim 17 further comprising means adapted for identifying a location of relevant markings on the template sheet.

19. The computer-readable medium for processing of electronic documents of claim 18 wherein the means adapted for identifying a location of relevant markings comprised as at least one of check boxes and fill-in boxes.

20. The computer-readable medium for processing of electronic documents of claim 17 further comprising means adapted for optically identifying handwritten characters on the template sheet.

21. The computer-readable for processing of electronic documents of claim 17 wherein the instruction signal directs routing of the electronic representation of a paper document in accordance with the instruction as indicated by optically identified handwritten characters.

22. The computer-readable medium for processing of electronic documents of claim 21 wherein the routing includes at least one of electronic mail transmission, facsimile transmission, FTP transmission, HTML transmission, and optical image rendering on an associated display.

23. The computer-readable medium for processing of electronic documents of claim 22 wherein the electronic representation of a paper document is routed to at least one of an electronic mail server, a document management system, an image generating device, and an Internet server.

24. The computer-readable medium for processing of electronic documents of claim 17 further comprising verification means adapted to verify the desired document processing operation.

25. A computer-implemented method for processing of electronic documents comprising the steps of:
generating an electronic representation of a paper document;
receiving an associated template sheet inclusive of an instruction representative of a desired document processing operation;
optically recognizing of the instruction;
generating an instruction signal in accordance with a recognized instruction; and
controlling processing of the electronic representation of a paper document in accordance with the instruction signal.

26. The computer-implemented method for processing of electronic documents of claim 25 further comprising the step of identifying a location of relevant markings on the template sheet.

27. The computer-implemented method for processing of electronic documents of claim 26 wherein identifying a location of relevant markings comprises identifying at least one of check boxes and fill-in boxes.

28. The computer-implemented method for processing of electronic documents of claim 25 further comprises the step of optically identifying handwritten characters on the template sheet.

29. The computer-implemented method for processing of electronic documents of claim 25 wherein the instruction signal directs routing of the electronic representation of a paper document in accordance with the instruction as indicated by optically identified handwritten characters.

30. The computer-implemented method for processing of electronic documents of claim 29 wherein the routing includes at least one of electronic mail transmission, facsimile transmission, FTP transmission, HTML transmission, and optical image rendering on an associated display.

31. The computer-implemented method for processing of electronic documents of claim 30 wherein the electronic representation of a paper document is routed to at least one of an electronic mail server, a document management system, an image generating device, and an Internet server.

32. The computer implemented method for processing of electronic documents of claim 25 further comprising the step of verifying the desired document processing operation.
